(19) United States
(12) Patent Application Publication
(10) Pub. No.: US 2014/0210642 A1
(43) Pub. Date: Jul. 31, 2014

(54) MOTORCYCLE DASHBOARD SYSTEM

(71) Applicant: National Taiwan University, Taipei (TW)

(72) Inventors: Ren-Chyuan LUO, Taipei (TW); Cheng-Jan CHI, Taipei (TW)

(73) Assignee: National Taiwan University, Taipei (TW)

(21) Appl. No.: 13/975,444

(22) Filed: Aug. 26, 2013

(30) Foreign Application Priority Data
Jan. 30, 2013 (TW) 102103558

(51) Int. Cl. B60K 37/02; H04B 7/00; H04B 5/00

(52) U.S. Cl. CPC B60K 37/02; H04B 5/0031; H04B 7/00
USPC 340/901

(57) ABSTRACT

A motorcycle dashboard system adapted to be used with a motorcycle is disclosed. The motorcycle dashboard system includes a wireless communication unit, a micro processor and a display unit. The wireless communication unit is configured to receive an external information by way of wireless transmission. The micro processor, electrically connected to the wireless communication unit, is configured to receive and process the external information and accordingly output a first display information. The display unit, electrically connected to the micro processor, is configured to display the first display information.

### TECHNICAL FIELD

The present invention relates to a motorcycle dashboard system, and more particularly to a motorcycle dashboard system with wireless transmission function.

### BACKGROUND

Today's motorcycle dashboard system is designed to provide the internal information (e.g., the oil measurement, the headlight ON/OFF or the right/left direction light indicator) to the motorcycle rider in one way manner; in other words, the motorcycle rider cannot upload the external information (e.g., the annual inspection date or the maintenance information, etc.) of the motorcycle to the motorcycle dashboard system. Accordingly, today's motorcycle dashboard system can only provide limited information.

In addition, some today's motorcycle dashboard systems are integrated with a Global Positioning System (GPS), such as the integrated motorcycle dashboard device disclosed in a Taiwan patent (Patent Publication No.: M378160). Thus, through the same motorcycle dashboard, the motorcycle rider can browse the positioning and navigation information provided by the GPS and the internal information. However, to get the positioning and navigation information, the motorcycle rider has to look down the motorcycle dashboard while riding the motorcycle and consequently driving dangers may occur.

### SUMMARY OF EMBODIMENTS

Therefore, an objective of the present invention is to provide a motorcycle dashboard system with wireless transmission function adapted to be used with a motorcycle.

The present invention provides a motorcycle dashboard system adapted to be used with a motorcycle. The motorcycle dashboard system includes a wireless communication unit, a micro processor and a display unit. The wireless communication unit is configured to receive an external information by way of wireless transmission. The micro processor, electrically connected to the wireless communication unit, is configured to receive and process the external information and accordingly output a first display information. The display unit, electrically connected to the micro processor, is configured to display the first display information.

In one embodiment, the wireless transmission is a Bluetooth connection or a wireless network connection.

In one embodiment, the external information is outputted from a mobile device.

In one embodiment, the mobile device is a mobile phone or a notebook computer.

In one embodiment, the external information comprises an annual inspection date or maintenance information of the motorcycle.

In one embodiment, the aforementioned motorcycle dashboard system further includes a Global Positioning System (GPS), electrically connected to the wireless communication unit and the display unit, configured to generate a positioning and navigation information according to a position of the motorcycle.

In one embodiment, the positioning and navigation information is wireless outputted via the wireless communication unit.

In one embodiment, the aforementioned motorcycle dashboard system further includes a sound output unit, electrically connected to the Global Positioning System, configured to output the positioning and navigation information in form of a sound.

In one embodiment, the micro processor is electrically connected to a plurality of sensors, the sensors are disposed in respective components of the motorcycle and configured to sense the respective components and accordingly output an internal information.

In one embodiment, the micro processor is further configured to receive and process the internal information and accordingly output a second display information, and consequentially the display unit is further configured to display the second display information.

In one embodiment, the internal information comprises the oil measurement, the headlight ON/OFF or the right/left direction light indicator of the motorcycle.

In summary, by being wireless transmitted with the external information (for example, the annual inspection date or the maintenance information, etc.) of a motorcycle from a mobile device, the motorcycle dashboard system of the present invention can display more information rather than the internal information (for example, the oil measurement, the headlight ON/OFF or the right/left direction light indicator) only. In addition, by being integrated with a GPS, the motorcycle dashboard system of the present invention can transmit the positioning and navigation information to a Bluetooth headset or a helmet with head-up display function of the motorcycle rider. Thus, motorcycle dashboard system of the present invention has enhanced effectively.

### BRIEF DESCRIPTION OF THE DRAWINGS

The above embodiments will become more readily apparent to those ordinarily skilled in the art after reviewing the following detailed description and accompanying drawings, in which:

FIG. 1 is a block diagram of a motorcycle dashboard system with wireless transmission function in accordance with an embodiment of the present invention; and

FIG. 2 schematically illustrates an exemplary appearance of the motorcycle dashboard system shown in FIG. 1.

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

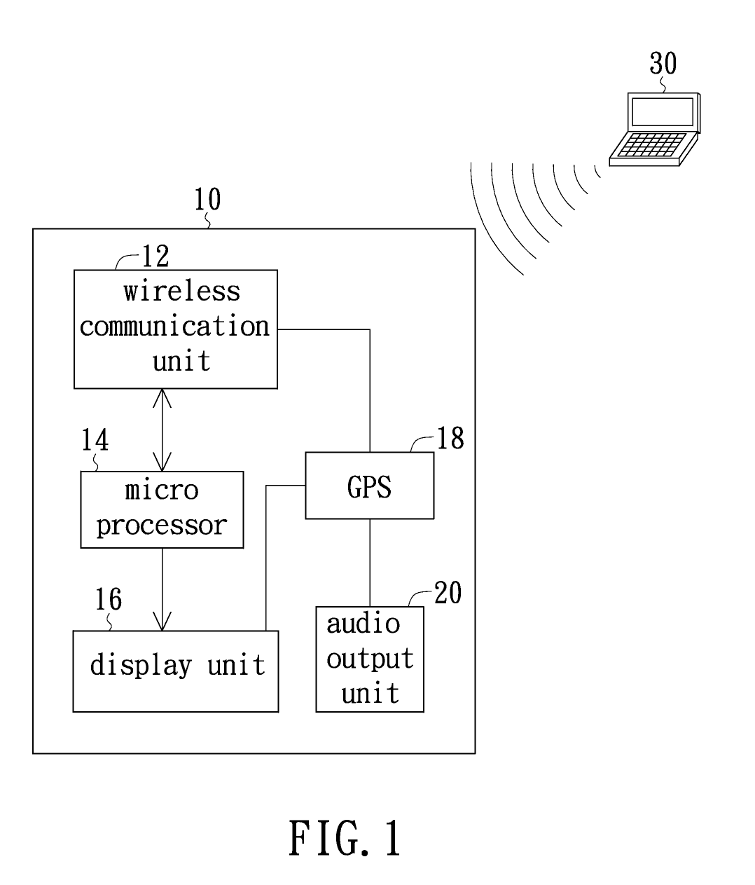

Please refer to FIG. 1, which illustrates a block diagram of a motorcycle dashboard system with wireless transmission function in accordance with an embodiment of the present invention. As shown, the motorcycle dashboard system 10 in this embodiment includes a wireless communication unit 12, a micro processor 14 and a display unit 16; wherein the micro processor 14 is electrically connected to the wireless communication unit 12 and the display unit 16.

The wireless communication unit 12 is wireless connected to a mobile device 30 (e.g., a mobile phone or a notebook computer); wherein the wireless connection between the wireless communication unit 12 and the mobile device 30 may be a Bluetooth connection or a wireless network connection. Specifically, while the wireless connection between the mobile device 30 and the wireless communication unit 12 is established, a motorcycle rider may be able to transmit external information associated with the motorcycle (for example, the annual inspection date or the maintenance information, etc.) stored in the mobile device 30 to the micro processor 14 via the wireless communication unit 12. After being received and processed by the micro processor 14, the external information may be displayed on the display unit 16. Because the motorcycle rider can wireless transmit the external information of the motorcycle to the motorcycle dashboard system 10, the dashboard system 10 is capable of displaying more information, compared with the conventional motorcycle dashboard system.

Furthermore, a Global Positioning System (GPS) may be integrated into the motorcycle dashboard system 10 with wireless transmission function. As illustrated in FIG. 1, the motorcycle dashboard system 10 further includes a GPS 18, which is electrically connected to the wireless communication unit 12 and the display unit 16.

As shown in FIG. 1, because the GPS 18 is electrically connected to the wireless communication unit 12, the positioning and navigation information generated by the GPS 18 can be wireless outputted via the wireless communication unit 12. For example, in one embodiment, if the motorcycle rider wears a Bluetooth headset and the Bluetooth headset is wireless connected to the wireless communication unit 12, the voice-form positioning and navigation information generated by the GPS 18 may be transmitted to the Bluetooth headset via the wireless communication unit 12, and thereby facilitating the voice navigation to the motorcycle rider. In another embodiment, if the motorcycle rider wears a helmet with head-up display function and the helmet is wireless connected to the wireless communication unit 12, the positioning and navigation information generated by the GPS 18 may be transmitted to and displayed on the windshield of the helmet, and thereby facilitating the navigation to the motorcycle rider. Thus, without being required to look down to browse the positioning and navigation information displayed on the motorcycle dashboard system, the motorcycle rider can be navigated by the positioning and navigation information directly displayed on the windshield of the helmet.

Furthermore, because the positioning and navigation information generated by the GPS 18 may be wireless outputted via the wireless communication unit 12, the motorcycle rider, while not staying with the motorcycle, can locate the motorcycle according to the positioning and navigation information if the wireless connection between the mobile device 30 and the wireless communication unit 12 of the motorcycle dashboard system 10 is established. For example, if cannot find the motorcycle in a parking lot, the motorcycle rider may use the mobile device 30, which is wireless connected to the wireless communication unit 12, to locate the motorcycle according to the positioning and navigation information transmitted from the GPS 18 to the mobile device 30.

In addition, because the GPS 18 is built in the motorcycle dashboard system 10 and electrically connected to the display unit 16, it is understood that the positioning and navigation information generated by the GPS 18 may be directly displayed on the display unit 16. Moreover, as shown in FIG. 1, the motorcycle dashboard system 10 may further include an audio output unit 20, which is electrically connected to the GPS 18 and configured to output the positioning and navigation information in form of audio. Furthermore, the audio output unit 20 may be further connected to a speakers or a headphone (not shown), through which the motorcycle rider can receive the positioning and navigation information in form of audio, and thereby facilitating the voice navigation to the motorcycle rider.

The micro processor 14 may be further connected to a plurality of sensors (not shown) disposed in the main respective components of the motorcycle. The sensors are configured to sense the respective components and thereby obtaining the internal information of the motorcycle (e.g., the oil measurement, the headlight ON/OFF or the right/left direction light indicator). After being received and processed by the micro processor 14, the internal information may be displayed on the display unit 16.

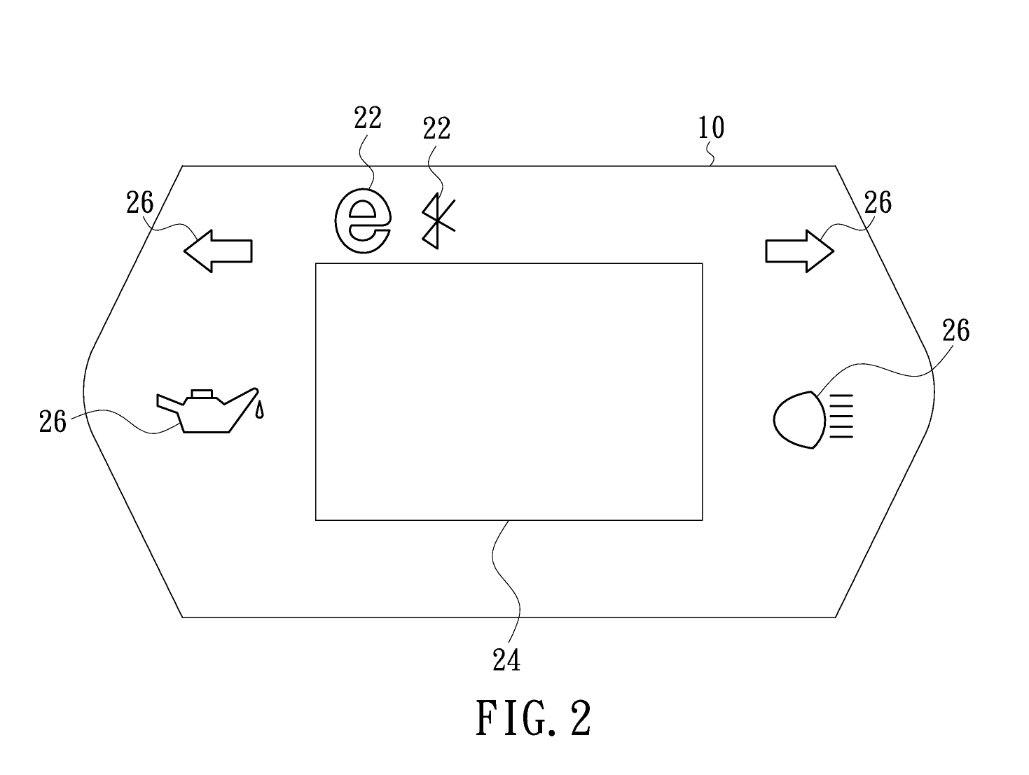

Please refer to FIG. 2, which schematically illustrates an exemplary appearance of the motorcycle dashboard system shown 10 in FIG. 1. As shown, the wireless connection (e.g., a Bluetooth connection or a wireless network connection) between the mobile device 30 and the wireless communication unit 12 is illustrated in the display area 22. In addition, the external information (e.g., the annual inspection date or the maintenance information) of the motorcycle and the positioning and navigation information provided by the GPS 18 is illustrated in the display area 24. Moreover, the internal information (e.g., the oil measurement, the headlight ON/OFF or the right/left direction light indicator) is illustrated in the display area 26.

In summary, by being wireless transmitted with the external information (for example, the annual inspection date or the maintenance information, etc.) of a motorcycle from a mobile device, the motorcycle dashboard system of the present invention can display more information rather than the internal information (for example, the oil measurement, the headlight ON/OFF or the right/left direction light indicator) only. In addition, by being integrated with a GPS, the motorcycle dashboard system of the present invention can transmit the positioning and navigation information to a Bluetooth headset or a helmet with head-up display function of the motorcycle rider. Thus, motorcycle dashboard system of the present invention has enhanced effectively.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A motorcycle dashboard system adapted to be used with a motorcycle, the motorcycle dashboard system comprising:
a wireless communication unit configured to receive an external information by way of wireless transmission;
a micro processor, electrically connected to the wireless communication unit, configured to receive and process the external information and accordingly output a first display information; and
a display unit, electrically connected to the micro processor, configured to display the first display information.

2. The motorcycle dashboard system according to claim 1, wherein the wireless transmission is a Bluetooth connection or a wireless network connection.

3. The motorcycle dashboard system according to claim 1, wherein the external information is outputted from a mobile device.

4. The motorcycle dashboard system according to claim 3, wherein the mobile device is a mobile phone or a notebook computer.

5. The motorcycle dashboard system according to claim 1, wherein the external information comprises an annual inspection date or maintenance information of the motorcycle.

6. The motorcycle dashboard system according to claim 1, further comprising a Global Positioning System (GPS), electrically connected to the wireless communication unit and the display unit, configured to generate a positioning and navigation information according to a position of the motorcycle.

7. The motorcycle dashboard system according to claim 6, wherein the positioning and navigation information is wireless outputted via the wireless communication unit.

8. The motorcycle dashboard system according to claim 6, further comprising a sound output unit, electrically connected to the Global Positioning System, configured to output the positioning and navigation information in form of a sound.

9. The motorcycle dashboard system according to claim 6, wherein the display unit is further configured to display the positioning and navigation information.

10. The motorcycle dashboard system according to claim 1, wherein the micro processor is electrically connected to a plurality of sensors, the sensors are disposed in respective components of the motorcycle and configured to sense the respective components and accordingly output an internal information.

11. The motorcycle dashboard system according to claim 10, wherein the micro processor is further configured to receive and process the internal information and accordingly output a second display information, and consequentially the display unit is further configured to display the second display information.

12. The motorcycle dashboard system according to claim 10, wherein the internal information comprises the oil measurement, the headlight ON/OFF or the right/left direction light indicator of the motorcycle.
